(19) United States
(12) Patent Application Publication
(10) Pub. No.: US 2026/0234434 A1
(43) Pub. Date: Aug. 13, 2026

(54) TWO-COMPONENT ACID-CURING COATING COMPOSITION AND COATED ARTICLE

(71) Applicant: SHERWIN-WILLIAMS (GUANGDONG) NEW MATERIAL CO., LTD., Guangdong (CN)

(72) Inventors: Wei YANG, Foshan City (CN); Mijin ADIKKALATHIL, Kerala (IN)

(21) Appl. No.: 19/149,573

(22) PCT Filed: Feb. 9, 2023
(86) PCT No.: PCT/CN2023/075215

§ 371 Date: Jul. 21, 2025

(51) Int. Cl. C09D 167/06

(52) U.S. Cl. CPC C09D 167/06

(57) ABSTRACT

The present application relates to a two-component acid-curing coating composition and coated article. In particular, the two-component acid-curing coating composition comprises a) a film-forming resin composition, said film-forming resin composition comprising at least one alkyd resin, at least one second resin, and at least one amino resin, and b) at least one acid catalyst, wherein the at least one second resin is incompatible with the at least one amino resin; and wherein the at least one alkyd resin is present in an amount of at least 20 wt. % relative to the total weight of the film-forming resin composition. In some embodiments of the present application, at least one second resin differs from at least one amino resin in density by at least 8%. In some embodiments of the present application, at least one second resin differs from at least one amino resin in solubility parameter by at least 20%. In some embodiments of the present application, a mixture of at least one second resin with at least one amino resin in a weight ratio of 1:1 has a transparency of no greater than 70%.

### TECHNICAL FIELD

The present application relates to a two-component acid-curing coating composition and coated article therefrom. More specifically, the present application relates to a two-component acid-curing coating composition with ultra-high surface paint film performances and a coated article made therefrom.

### BACKGROUND

Acid-curing (AC) coating is a kind of coating previously applied in the coating industry, where an acid catalyst is used to accelerate the cross-linking and curing of an amino resin and a hydroxyl functional resin. The AC coating has the advantages of hard and wear-resistant paint films; high heat, water and cold resistance of paint films; good transparency; good yellowing resistance; and no isocyanates compared to two-component (2K) polyurethane (PU) coatings. Therefore, the acid-curing coating compositions are well suited for the coating of wood substrates, especially for furniture wood.

In recent years, there has been an increasing demand for acid-curing coating compositions and consequently for performances especially surface performances of acid-curing paint films. Currently, the commercially available acid-curing paint films have the specifications of an interlayer adhesion of up to 5 kg and a surface scratch resistance of up to 150 g, which are far from meeting the demand for surface performances of acid-curing paint films.

For this reason, there is a need for an improved two-component acid-curing coating composition in the coatings industry, especially those two-component acid-curing coating composition having ultra-high surface paint film performances.

### SUMMARY

The present application provides, in one aspect, a two-component acid-curing coating composition comprising a) a film-forming resin composition, said film-forming resin composition comprising at least one alkyd resin, at least one second resin, and at least one amino resin, and b) at least one acid catalyst, wherein the at least one second resin is incompatible with the at least one amino resin; and wherein the at least one alkyd resin is present in an amount of at least 20 wt. % relative to the total weight of the film-forming resin composition.

In some embodiments of the present application, at least one second resin differs from at least one amino resin in density by at least 8%. In some embodiments of the present application, at least one second resin differs from at least one amino resin in solubility parameter by at least 20%. In some embodiments of the present application, a mixture of at least one second resin with at least one amino resin in a weight ratio of 1:1 has a transparency of no greater than 70%.

The present application further provides an article, said article comprising a substrate having at least one major surface; and a coating applied directly or indirectly to at least a portion of said major surface of said substrate, wherein said coating is formed from the two-component acid-curing coating composition of the present application. Preferably, said substrate is selected from wood, wood composite, paper, metal, plastic, fabric, ceramic, cementious material, or any combination thereof, more preferably, said substrate is selected from wood, wood composite or any combination thereof.

It was surprisingly discovered that in the formulation of two-component acid-curing coating compositions, particularly in the formulation of a film-forming resin composition contained in two-component acid-curing coating compositions comprising at least one alkyd resin and at least one amino compound, by controlling the amount of the alkyd resin, it is possible to solve the issue that the at least one second resin, for example a hydroxyl functional polyester is incompatible with the at least one amino resin to achieve their homogenous blending. In this way, not only can a uniformly dispersed coating composition be obtained, but the paint film formed by such a formulated coating composition has significantly better surface performances while maintaining flexibility, which was not expected before this application. The paint film formed by the resulting coating composition has significantly better interlayer adhesion and surface scratch resistance both while maintaining flexibility.

Moreover, it was surprisingly found that in the formulation of a film-forming resin composition contained in two-component acid-curing coating compositions comprising at least one alkyd resin and at least one amino compound, the surface performances of the paint film formed from the two-component acid-curing coating composition can be further improved by adding a fluorocarbon resin-modified acrylic polymer and combining it with the above-mentioned second resin, especially a hydroxyl-functional polyester, so that the paint film formed therefrom can pass a 200 g Hoffman test after 30 days of curing.

Details of one or more embodiments of the present application are set forth in the following specification. Other features, purposes and advantages of the present application will become clear in light of the specification and claims.

### Definition

As used herein, “a”, “an”, “the”, “at least one”, and “one or more” are used interchangeably. Thus, for example, a coating composition that comprises “an” additive can be interpreted to mean that the coating composition includes “one or more” additives. Unless otherwise noted herein, the use of the singular form in the present application is also intended to include the plural form.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this application, as along as such components or steps do not affect the basic and novel characteristics of the application, but it is also contemplated that the compositions or processes may consist essentially of, or consist of, the recited components or steps.

In the present application, the range of values recited by endpoints includes all values within that range. For example the range 1 to 5 covers the values of 1, 1.5, 2, 2.75, 3, 3.80, 4, 5, and the like. Further, the disclosed range of values includes all subset ranges within that wider range, e.g., the range of 1 to 5 includes sub ranges of 1 to 4, 1.5 to 4.5, 1 to 2, and the like.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

When used in connection with a “two-component acid-curing coating composition”, the term “film-forming composition” refers to a composition consisting primarily of one or more resin component, which is used as component A of the two-component acid-curing coating composition, and which is capable of forming a non-tacky continuous film on said substrate when the composition, when mixed with at least one acid catalyst, is applied to a substrate and then is dried, cross-linked or otherwise hardened.

As used herein, the term “second resin” refers to a resin that is different in kind and nature from the alkyd resin contained in the film-forming resin composition, but that can also participate in cross-linking and/or hardening of the coating. In some embodiments of the present invention, the second resin comprises a hydroxyl-functional polyester, preferably a linear hydroxyl-functional polyester.

As used herein, the phrase “said at least one second resin is incompatible with said at least one amino resin” means that the mixed system of the second resin and the amino resin formed by stirring, dispersion or dispersing means commonly used in the coatings field is subject to phase separation, delamination and/or density inhomogeneity when it was allowed to stand at room temperature for a certain time frame, e.g., 24 hours or less. By way of illustration, one or more of the following can result in the above incompatibility: densities of the second resin and the amino resin are different; solubility parameters of the second resin and the amino resin are different; and a mixture of the second resin to the amino resin in a weight ratio of 1:1 is opaque or semi-opaque.

As used herein, the term “solubility parameter” is a parameter used to measure the solubility of a solvent to a polymer. Generally, the closer the solubility parameters of two or more polymers are, the more compatible these polymers are. Conversely, the greater the difference between solubility parameters of two or more polymers, the less compatible these polymers are.

As used herein, the term “amino resin” refers to a product formed by condensation of an amino compound, i.e., a compound containing at least one primary amine (NH₂) functional group and/or an amide (—CO—NH₂) functional group, with an aldehyde compound, optionally partially or fully etherified by an aliphatic monohydric alcohol.

When used in connection with an “alkyd resin” and a “second resin”, the term “hydroxyl value” refers to the number of milligrams of potassium hydroxide that corresponds to the hydroxyl content per gram of the corresponding resin. The hydroxyl value can be determined by methods well known in the art. For example, the hydroxyl value is determined according to DIN EN ISO 4629: 2016.

As used herein, “coating” has the same meaning as “paint film”, which are formed by the application and curing of a solvent-borne acid-curing coating composition.

The terms “preferred” and “preferably” refer to embodiments of the application that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the application.

### DESCRIPTION OF DRAWINGS

FIG. 1 is a photograph of coatings formed from the mixture of an amino resin, an alkyd resin, a polyester resin and a butyl acetate at different dosage ratios (samples 1-5) on a glass plate, including FIGS. 1A to 1E.

### DETAILED DESCRIPTION

The present application provides, on the one hand, a two-component acid-curing coating composition comprising a) a film-forming resin composition, said film-forming resin composition comprising at least one alkyd resin, at least one second resin, and at least one amino resin, and b) at least one acid catalyst, wherein the at least one second resin is incompatible with the at least one amino resin; and wherein the at least one alkyd resin is present in an amount of at least 20 wt. % relative to the total weight of the film-forming resin composition.

Currently, the commercially available acid-curing paint films have the specifications of an interlayer adhesion of up to 5 kg and a surface scratch resistance of up to 150 g, which are far from meeting the demand for surface performances of acid-curing paint films. In addition, acid-curing coating compositions have been suffering from poor flexibility of the resulting paint film. To adjust flexibility of the paint film formed from acid-curing coating compositions, plasticizers or soft resins, such as castor oil alkyd resins, vinyl resins, and cellulose acetate resins, are commonly used in the field, which would inevitably lead to the problem that the resulting coatings were prone to adhesion with each other during lamination, packaging, transportation, and the like. Thus, providing a coating composition that can simultaneously provide a paint film or coating with acceptable paint film flexibility and excellent surface performances is a difficult technical problem to solve at present.

It is well known that a coating, as a composition suitable for coating on the surface of a substrate, is usually in the form of a macroscopically homogeneous composition, taking into account its storage, construction and other factors. Therefore, in the formulation of coating compositions, two incompatible resins are usually regarded as film-forming resins that are not suitable for coexistence. However, it was surprisingly discovered by the inventors that in the formulation of two-component acid-curing coating compositions, particularly in the formulation of a film-forming resin composition contained in two-component acid-curing coating compositions comprising at least one alkyd resin and at least one amino compound, by controlling the amount of the alkyd resin, it is possible to solve the issue that at least one second resin, for example a hydroxyl functional polyester is incompatible with the at least one amino resin to achieve their homogenous blending. In this way, not only can a uniformly dispersed coating composition be obtained, but the paint film formed by such a formulated coating composition has significantly better surface performances including interlayer adhesion and surface scratch resistance both while maintaining flexibility, which was not expected before this application.

In embodiments of the present application, one or more of the following can result in incompatibility of at least one second resin and at least one amino resin: densities of the second resin and the amino resin are different; solubility parameters of the second resin and the amino resin are different; and the mixture of the second resin to the amino resin in a weight ratio of 1:1 is opaque or semi-opaque.

In some embodiments of the present application, at least one second resin differs from at least one amino resin in density by at least 8%, preferably at least one second resin differs from at least one amino resin in density by at least 10%, more preferably at least one second resin differs from at least one amino resin in density by at least 12% and no greater than 20%. As used herein, the term “density” is used as a parameter to measure the specific gravity of a polymer. It was surprisingly found by the inventors of the present application that a second resin such as a hydroxyl-functional polyester is incompatible with an amino resin with a density difference of at least 8% and that when these two resins are used, the film-forming resin compositions so formulated could significantly improve surface performances of the paint film without sacrificing flexibility of the paint film, which was not expected prior to this application. It was further surprisingly found by the inventors of the present application that if the difference in density between said at least one second resin and said at least one amino resin is too small, the improvement in surface performances of the paint film formed from the acid-curing coating composition as formulated therefrom is limited; and if the difference in density between said at least one second resin and said at least one amino resin is too large, the acid-curing coating composition formulated therefrom is unstable.

In addition, it was found by the inventors of the present application that the choice that the second resin has a lower density than the amino resin is important for improving surface performances of the paint film. Preferably, at least one second resin has a density lower than at least one amino resin by at least 8%, preferably by at least 10%, more preferably by at least 12% and no greater than 20%.

In some embodiments of the present application, at least one second resin differs from at least one base alkyd resin in solubility parameter by at least 20%, preferably at least one second resin differs from at least one amino resin in solubility parameter by at least 25%, more preferably at least one second resin differs from at least one amino resin in solubility parameter by at least 30% and no greater than 60%. As used herein, the term “solubility parameter” is used as a parameter used to measure the solubility of a solvent to a polymer. Generally, the closer the solubility parameters of two or more polymers are, the more compatible these polymers are. Conversely, the greater the difference between solubility parameters of two or more polymers, the less compatible these polymers are. It was surprisingly found by the inventors of the present application that a second resin such as a hydroxyl-functional polyester is incompatible with an amino resin with a solubility parameter difference of at least 20% and that when these two resins are used, the film-forming resin compositions so formulated could significantly improve surface performances of the paint film without sacrificing flexibility of the paint film, which was not expected prior to this application. It was further surprisingly found by the inventors of the present application that if the difference in solubility parameter between said at least one second resin and said at least one amino resin is too small, the improvement in surface performances of the paint film formed from the acid-curing coating composition as formulated therefrom is limited; and if the difference in solubility parameter between said at least one second resin and said at least one amino resin is too large, the acid-curing coating composition formulated therefrom is unstable. Therefore, it is preferred that at least one second resin differs from at least one amino resin in solubility parameter by at least 20%, preferably by at least 25%, more preferably by at least 30% and no greater than 60%.

In still other embodiments of the present invention, a mixture of at least one second resin with at least one amino resin in a weight ratio of 1:1 is opaque or semi-translucent. It was found by the inventors of the present application that when a mixture of at least one second resin for example a hydroxyl-functional polyester with at least one amino resin in a weight ratio of 1:1 has a transparency of no greater than 70%, the second resin can be considered incompatible with the amino resin and the film-forming resin composition so formulated therefrom can significantly improve surface performances of the paint film without sacrificing flexibility of the paint film.

Not being bound by any theory, the inventors of the present application believe that in the formulation of the film-forming resin composition of the two-component acid-curing coating composition, the alkyd resin acts as an “intermediary” to enable the incompatible amino resin and second resin to form a uniformly dispersed mixture; after the coating composition is applied to a substrate, the two incompatible resins in the film-forming resin composition undergo micro-phase separation during a film formation process, and the second resin readily aggregates on the surface of the resulting coating or paint film, thereby enhancing its surface performances.

Moreover, it was surprisingly found that in the formulation of a film-forming resin composition contained in two-component acid-curing coating compositions comprising at least one alkyd resin and at least one amino compound, the surface performances of the paint film formed from the two-component acid-curing coating composition can be further improved by adding a fluorocarbon resin-modified acrylic polymer and combining it with the above-mentioned second resin, especially a hydroxyl-functional polyester, so that the paint film formed therefrom can pass a 200 g Hoffman test after 30 days of curing.

In embodiments according to the present application, the two-component acid-curing coating composition comprises a) a film-forming resin composition. As used herein, the film-forming resin composition refers to a composition consisting primarily of one or more resin component, which is used as component A of the two-component acid-curing coating composition, and which is capable of forming a non-tacky continuous film on said substrate when the composition, when mixed with at least one acid catalyst, is applied to a substrate and then is dried, cross-linked or otherwise hardened.

In the two-component acid-curing coating composition according to the present application, the film-forming resin composition comprises at least one alkyd resin, at least one second resin and at least one amino resin, which, as a resin component or a part of a resin component, form main body of coating formed by the two-component acid-curing coating composition so as to provide sufficient mechanical strength for the resulting coating.

In an embodiment according to the present application, an alkyd resin is used as a base resin. The term “alkyd resin” is used herein to refer to a liquid alkyd resin made by condensation polymerization of a polyol, polyacid or anhydride together with an unsaturated fatty acid; or to a liquid alkyd resin made by transesterification of a polyol with a fatty oil, which is also referred to as a fatty acid or fatty oil modified polyester. Representative polyols include glycerol, pentaerythritol, sorbitol, trimethylolpropane, ethylene glycol, diethylene glycol, propylene glycol, dipropylene glycol, and other polyols known to those of ordinary skill in the art for use in the preparation of alkyd resins. Representative polyacids or anhydrides include dibasic acids or anhydrides such as phthalic acid and its anhydride, isophthalic acid, terephthalic acid, maleic acid, fumaric acid, adipic acid, sebacic acid, and the like; ternary acids such as trimellitic acid; and other polyacids or anhydrides known to those of ordinary skill in the art for use in the preparation of alkyd resins. Representative fatty acids include dehydrated castor fatty acids, flax fatty acids, ricin fatty acids, soy fatty acids, and combinations thereof. Representative fatty oils include vegetable oils such as carona oil, castor oil, dehydrated castor oil, coconut oil, corn oil, cottonseed oil, groundnut oil, linseed oil, peanut oil, safflower oil, soybean oil, sunflower oil, tall oil, tung oil, walnut oil, wood oil, and the like; animal fats such as fish oil, lard, chicken oil, tallow, and the like; and combinations thereof.

In some embodiments of the present invention, said alkyd resin comprises at least one saturated fatty acid-based alkyd resin with low oil content, at least one saturated fatty acid-based alkyd resin with medium oil content, at least one saturated fatty acid-based alkyd resin with high oil content, at least one saturated fatty acid-based alkyd resin with extreme high oil content, or combinations thereof. As used herein, the term “oil content” is defined as the content of vegetable oil or fatty acid in an alkyd resin. Typically, alkyd resins with an oil content value of 35-45% are referred to as alkyd resins with low oil content; alkyd resins with an oil content value of 46-55% are referred to as alkyd resins with medium oil content; alkyd resins with an oil content value of 56-70% are referred to as alkyd resins with high oil content; and alkyd resins with an oil content value greater than 70% are referred to as alkyd resins with extreme high oil content. In a preferred embodiment of the present invention, the alkyd resin comprises at least one saturated fatty acid-based alkyd resin with low oil content.

In an embodiment according to the present application, the alkyd resin has a hydroxyl value in the range of 140 to 240 mg KOH/g resin, preferably in the range of 140-200 mg KOH/g resin, more preferably in the range of 140-180 mg KOH/g resin, and still more preferably in the range of 145-170 mg KOH/g resin, so that the desired curing effect may be achieved. Said hydroxyl values are determined according to DIN EN ISO 4629: 2016. If the hydroxyl value of the alkyd resin is too high, it gels too quickly after mixing with an amino resin and is not suitable for construction operations; if the hydroxyl value of the alkyd resin is too low, its curing reaction with an amino resin is too slow, resulting in reduced construction efficiency. Therefore, in some embodiments according to the present application, the hydroxyl value of the alkyd resin is appropriate within the above-mentioned range, which makes the coating composition formulated therefrom with a suitable pot life.

In an embodiment according to the present application, the alkyd resin has a density in the range of 1.09 to 1.10 g/cm³. Said density is usually provided by the product supplier.

As described above, the alkyd resins can be prepared by suitable preparation methods known to those of ordinary skill in the art, or can be obtained from any suitable commercially available product. As commercial examples of alkyd resins, alkyd resins such as CY468, CY472, CY474, CY499 purchased from DSM in the Netherlands; or Novalkyd 2510X80C, 2530X80C, 252, 252X75, 3731X70C, 3737X70C, 3800X60C, 3800XA165, 3811AB80, 3815X70C, 3820X60, 3823, 3910X60, 3911X70, 8AL231X6 purchased from DSM in the Netherlands; and Allnex Setal 84 from Allnex.

As described above, in the formulation of the film-forming resin composition of the two-component acid-curing coating composition, the alkyd resin acts as an “intermediary” to enable the incompatible amino resin and second resin to form a uniformly dispersed mixture. Therefore, the amount of alkyd resin is an important feature to achieve the above effect. It was surprisingly discovered that in the formulation of a film-forming resin composition contained in two-component acid-curing coating compositions, by controlling the alkyd resin in an amount of at least 20 wt. % relative to the total weight of the film-forming resin composition, it is possible to solve the issue that the at least one second resin, for example a hydroxyl functional polyester is incompatible with the at least one amino resin so as to form a uniformly dispersed coating composition. In one embodiment according to the present application, the alkyd resin may be present in an amount of not more than 69 wt. %, not more than 65 wt. %, not more than 60 wt. %, and at least 20 wt. %, at least 30 wt. %, at least 35 wt. %, at least 40 wt. %, relative to the total weight of said film-forming composition. In a preferred embodiment according to the present application, the alkyd resin is present in an amount of 20 to 35 wt. %, relative to the total weight of the film-forming resin composition.

In some embodiments of the present invention, said second resin comprises a hydroxyl-functional polyester. Preferably, the hydroxyl-functional polyester is a linear hydroxyl-functional polyester. For example, said hydroxyl-functional polyester is a linear hydroxyl-functional polyester with an average functionality of about 2, formed from a dicarboxylic acid and a diol by polycondensation, for example. Hydroxyl-functional polyesters with a linear structure are advantageous for formulating acid-curing coating compositions with good leveling properties, and acid-curing coating compositions formed therefrom have superior surface performances than similar acid-curing coating compositions formulated from hydroxyl-functionalized polyesters with a branched structure.

In an embodiment according to the present application, the hydroxyl functional polyester has a hydroxyl value in the range of 140 to 400 mg KOH/g resin, preferably in the range of 145-380 mg KOH/g resin, more preferably in the range of 150-350 mg KOH/g resin, and still more preferably in the range of 155-330 mg KOH/g resin, so that the desired curing effect can be achieved. The mentioned hydroxyl values are determined according to DIN EN ISO 4629:2016. If the hydroxyl value of the hydroxyl-functional resin is too high, it gels too quickly after mixing with the amino resin and is not suitable for construction operations; if the hydroxyl value of the hydroxyl-functional resin is too low, the curing reaction with the amino resin is too slow, resulting in reduced construction efficiency. Therefore, in some embodiments according to the present application, the hydroxyl value of the hydroxyl functional resin is appropriate within the above-mentioned range, which makes the coating composition formulated therefrom have a suitable pot life.

Moreover, it was found by the inventors of the present invention that hydroxyl value of the hydroxyl-functional polyester is important for improving surface performances of the paint film formed from the acid-cured paint composition formulated therefrom and that the acid-curing coating composition formulated from the hydroxyl-functional polymer with a particular hydroxyl value has superior surface performances compared to similar acid-curing coating compositions formulated from other hydroxyl-functionalized polyesters, which was unexpected prior to the present application. Thus, in some embodiments of the present invention, the hydroxyl-functional polyester has a hydroxyl value in the range of 140-240 mg KOH/g resin, preferably 140-200 mg KOH/g resin, more preferably 140-180 mg KOH/g resin. In some preferred embodiments of the present invention, the hydroxyl-functional polyester has a hydroxyl value in the range of 260-400 mg KOH/g resin, preferably 290-380 mg KOH/g resin, and more preferably 300-350 mg KOH/g resin.

In an embodiment according to the present application, the second resin has a density in the range of 0.97 to 0.99 g/cm³.

In an embodiment according to the present application, the second resin has a solubility parameter in the range of 20 (J/cm³)^{1/2} to 25 (J/cm³)^{1/2}. Said solubility parameter is experimentally measurable and can also be theoretically calculated.

In an embodiment according to the present application, a mixture of the second resin with an amino resin in a 1:1 weight ratio has a transparency of not more than 70%, and the paint film formed therefrom is indistinct.

By way of exemplary illustration, said hydroxyl-functional polyester may be commercially available or may be prepared as desired. In some embodiments according to the present invention, said polyester resin may be a commercially available K-FLEX188 polyester polyol resin from King's, USA.

In one embodiment according to the present application, the amount of the second resin can vary over a wide range. For example, the second resin may be no more than 69 wt. %, no more than 65 wt. %, no more than 60 wt. %, and at least 1 wt. %, at least 3 wt. %, at least 5 wt. %, at least 10 wt. %, relative to the total weight of said film forming composition. In a preferred embodiment according to the present application, the second resin is present in an amount in the range of 1 to 30 wt. %, preferably in the range of 1 to 25 wt. %, more preferably in the range of 1 to 10 wt. %, relative to the total weight of the film forming resin composition. Typically, the desired amount of second resin can be selected empirically, usually based on the film-forming properties of the paint film.

In some embodiments according to the present application, the film-forming composition comprises an amino resin in addition to the alkyd resin and second resin described above.

As mentioned above, the amino resin is a condensation product of aldehydes (e.g., formaldehyde, acetaldehyde, crotonaldehyde, and benzaldehyde) and amino compounds containing amino or amide groups (e.g., urea, melamine, phenyl-substituted melamine, or methyl melamine). Other condensation products of amines and amides, such as aldehyde condensates of triazine, diazine, triazole, guanidine, guanidinium, and alkyl-substituted and aryl-substituted melamines, can also be used. Some examples of such compounds are N,N′-dimethylurea, benzoylurea, dicyandiamide, methylguanidine, ethylguanidine, glycylurea, melamine diamide, 2-chloro-4,6-diamino-1,3,5-triazine, 6-methyl-2,4-diamino-1,3,5-triazine, 3,5-diaminotriazole, triamino-pyrimidine, 2-mercapto-4,6-diamino-pyrimidine, 3,4,6-tris(ethylamino)-1,3,5-triazine, and the like. Although the aldehyde used is usually formaldehyde, other aldehydes may be used, such as acetaldehyde, crotonaldehyde, acrolein, benzaldehyde, furfural, glyoxal, and mixtures thereof. In the presently preferred embodiment of the present application, melamine-formaldehyde, phenyl-substituted melamine-formaldehyde, glyoxal-formaldehyde, methyl melamine-formaldehyde, or combinations thereof are used as the amino resin.

In some preferred embodiments according to the present application, the amino resin may be optionally partially alkylated. In some embodiments, the amino resin is an amino resin etherified by n-butanol, an amino resin etherified by isobutanol, an amino resin etherified by methanol, or any combination thereof. Particularly preferably, the amino resin according to some embodiments of the present application comprises an amino resin that is not fully etherified.

The amino resins are commercially available, and non-limiting examples of suitable amino resins may include Cymel 303LF, Cymel 1123, Cyeml 1170, Cymel 325, and the like from Allnex.

In an embodiment according to the present application, the amino resin has a density in the range of 1.08 to 1.10 g/cm³.

In an embodiment according to the present application, the amino resin has a solubility parameter in the range of 16.0 (J/cm³)^{1/2} to 20.0 (J/cm³)^{1/2}. Said solubility parameter is experimentally measurable and can also be theoretically calculated.

The amount of amino resin may depend on various factors including, for example, the type of amino resin, the time and temperature of baking, the molecular weight of the alkyd resin and second resin, and the desired coating properties. Based on the total weight of the film-forming composition, the amino resin is typically present in an amount of up to 60 wt. %, preferably up to 55 wt. %, more preferably up to 50 wt. %, and in an amount of at least 20 wt. %, at least 25 wt. %, at least 30 wt. %, or at least 35 wt. %. In a preferred embodiment according to the present application, the amount of amino resin, relative to the total weight of the film forming composition, is in the range of 20 to 50 wt. %, preferably in the range of 20 to 40 wt. %, more preferably in the range of 20 to 30 wt. %. Typically, the desired amount of amino resin can be selected empirically based on the film-forming properties of the paint film.

In some embodiments according to the present invention, the film-forming resin composition may further comprise at least one fluorocarbon resin-modified acrylics polymer. In the context of the present invention, a fluorocarbon resin modified acrylic polymer is an agent that has limited compatibility with resin components of the film forming resin composition, including but not limited to alkyd resins, second resins and amino resins, and that is able to migrate to the surface of the coating to form a new resin film layer. As used herein, the term “fluorocarbon resin modified acrylics polymer” includes fluorocarbon resin modified poly(meth)acrylate homopolymer or copolymer.

In one embodiment according to the present invention, the molecular weight of the fluorocarbon resin-modified acrylics polymer is a factor affecting its compatibility with other components of the film-forming resin composition, such as the resin component. In the present invention, the fluorocarbon resin-modified acrylics polymer has a weight average molecular weight in the range of 6,000 to 20,000 g/mol, and preferably has a weight average molecular weight in the range of 8,000 to 12,000 g/mol. Said weight average molecular weight is determined by GPC. If the molecular weight is too high, the compatibility is too poor and the polymer cannot be uniformly distributed on the coating surface; if the molecular weight is too low, durability of the coating film becomes poor. The fluorocarbon resin-modified acrylics polymer with the above mentioned weight average molecular weight has good leveling properties.

In one embodiment according to the present invention, the density of the fluorocarbon resin modified acrylics polymer is also a factor affecting its compatibility with other components in the film forming resin composition, such as resin components. In the present invention, the density of the fluorocarbon resin-modified acrylics polymer is lower than the density of other components of the film-forming resin composition, such as the resin component, and preferably, the density of the fluorocarbon resin-modified acrylics polymer is lower than the density of both the alkyd resin and the second resin. If the density of the fluorocarbon resin-modified acrylics polymer is greater than the density of both the alkyd resin and the second resin, it is difficult for the fluorocarbon resin-modified acrylics polymer to be uniformly distributed on the surface of the coating, resulting in a decrease in surface performances of the coating film. In one embodiment according to the present invention, the fluorocarbon resin-modified acrylics polymer has a density in the range of 0.8-1.0 g/cm³.

The fluorocarbon resin-modified acrylics polymers can be prepared by suitable methods known to those of ordinary skill in the art, for example by homopolymerization of acrylics monomers. Alternatively, any suitable commercially available product can be used, such as acrylics polymers from Ciba such as EFKA 3777, EFKA3772, EFKA3600, EFKA3500; fluorocarbon modified acrylic additives such as BETTERSOL3987 from Shanghai Cang Hong Industrial Co.

In one embodiment according to the present application, the amount of fluorocarbon resin-modified acrylics polymer can vary over a wide range. For example, the fluorocarbon resin-modified acrylic polymer may be present in an amount of no more than 10 wt. %, no more than 8 wt. %, no more than 5 wt. %, and at least 0 wt. %, at least 0.5 wt. %, at least 1 wt. %, relative to the total weight of said film forming composition. In a preferred embodiment according to the present application, the amount of fluorocarbon-resin modified acrylic polymer, relative to the total weight of the film forming resin composition, is in the range of 0 to 2 wt. %, preferably in the range of 0.1 to 2 wt. %. Typically, the desired amount of fluorocarbon resin-modified acrylic polymer may be selected empirically, usually based on the film-forming properties of the paint film.

In some embodiments according to the present invention, the film-forming resin composition may also comprise an amount of epoxy resin. Said epoxy resin may be any epoxy resin known in the art. In a preferred embodiment according to the present invention, the amount of epoxy resin, relative to the total weight of the film-forming resin composition, is in the range of 0 to 2 weight percent, preferably in the range of 0.1 to 2 weight percent. It was surprisingly found by the inventors of the present invention that the additional addition of epoxy resin to the film-forming resin composition can further improve the overall surface performances of paint film formed from the acid-cured coating composition, wherein the paint film formed therefrom has not only optimal scratch resistance but also optimal interlayer adhesion, which was unexpected prior to the present application.

In some embodiments according to the present application, the film-forming resin composition may further comprise an organic solvent to further modulate viscosity of the coating composition. The addition of the organic solvent can increase evaporation rate of the coating composition and accelerate formation of the paint film. In some embodiments of the present application, said organic solvents include ketones (e.g. acetone, methyl isopropyl ketone, methyl isobutyl ketone, etc.), esters (ethyl acetate, butyl acetate, etc.), aromatics (toluene, xylene, etc.), aliphatic hydrocarbons (cyclopentane, cyclohexane, etc.), or any combination thereof.

In a preferred embodiment according to the present application, the solvent, if present, can be, for example, at least 0.1 wt. %, at least 1 wt. %, at least 3 wt. %, at least about 5 wt. %, at least about 6 wt. %, at least about 7 wt. %, at least about 8 wt. %, at least about 9 wt. %, at least about 10 wt. % of the total weight of the film-forming composition. In a preferred embodiment according to the present application, the solvent, if present, may be, for example, up to about 50 wt. %, up to about 45 wt. %, up to about 40 wt. %, up to about 30 wt. %, or up to about 20 wt. % of the total weight of the film-forming composition. Typically, the desired solvent amount is typically selected empirically based on film forming properties of the paint film.

In some embodiments according to the present application, the film-forming composition in the two-component acid-curing coating composition may also comprise optional additional additives, said optional additional additives being those commonly used in coating compositions. These additives do not adversely affect the coating composition or the cured coating obtained therefrom. Suitable additives include, for example, those agents that will improve processing or manufacturing properties of the composition, enhance aesthetics of the composition, or improve specific functional properties or characteristics of the coating composition or the cured composition obtained therefrom, such as adhesion to the substrate. Depending on specific needs, additives may include in the film forming composition such as, but not limited to, anti-caking agents, drying agents, film forming aids, coupling agents, pigments, fillers, anti-settling agents, anti-migration aids, antimicrobial agents, anti-mold agents, lubricants, wetting agents, biocides, plasticizers, defoamers, colorants, waxes, antioxidants, anti-corrosion agents, rheology aids, dispersants, adhesion promoters, UV stabilizers, leveling agents, or combinations thereof. The amount of each optional ingredient is sufficient to serve its intended purpose, but preferably in such a way that it does not adversely affect the coating composition or the cured coating obtained therefrom. Preferably, the additional additives comprise pigments, fillers, thickeners, anti-settling agents, dispersants, wetting agents, film forming aids, coupling agents, fungicides, anti-mold agents or any combination thereof.

In some embodiments according to the present application, the total amount of additional additives is in the range of about 0 wt. % to about 5 wt. %, preferably in the range of about 0.1 wt. % to about 5 wt. %, relative to the total weight of the film-forming composition.

In a specific embodiment according to the present application, the film-forming composition of the two-component acid-curing coating composition comprises, relative to the total weight of said film-forming composition,
20-25 wt. % of said at least one alkyd resin,
1-30 wt. %, preferably 1-10 wt. % of said at least one second resin,
20-30 wt. % of said at least one amino resin,
0-2 wt. % of said at least one fluorocarbon resin-modified acrylics polymer;
2-40 wt. % of at least one solvent; and
0-5 wt. % of said additional additives, said additional additives comprising at least one pigment, at least one filler, at least one anti-setting agent, at least one thickener, at least one dispersant, at least one wetting agent, at least one film forming aid, at least one coupling agent, at least one fungicide, at least one anti-mold agent or any combination thereof.

In addition, in embodiments according to the present application, the two-component acid-curing coating composition may further comprise at least one acidic catalyst as Component B. Examples of acidic catalysts include, but are not limited to, p-toluenesulfonic acid, benzenesulfonic acid, methanesulfonic acid, dinonylnaphthalenesulfonic acid, dinonylnaphthalenedisulfonic acid, dodecylbenzenesulfonic acid, oxalic acid, maleic acid, phthalic acid, acrylic acid, mono(di)alkyl phosphate, phosphoric acid, mono(di)alkyl pyrophosphate, or combinations thereof.

In the two-component acid-curing coating compositions according to the present application, the amount of the acidic catalyst can be adjusted as desired empirically by those skilled in the art, in particular according to the amount of alkyd resin, second resin and/or amino resin. In some embodiments of the present application, the acidic catalyst is present in an amount of at most 15 wt. %, at most 13 wt. %, at most 12 wt. %, at most 10 wt. %, at most 8 wt. %, at most 5 wt. %, and at least 0.1 wt. %, at least 0.2 wt. %, at least 0.5 wt. %. In some preferred embodiments of the present application, the acidic catalyst is present in an amount in the range of 0.1-10 wt. %, preferably in the range of 0.2-8 wt. %, more preferably in the range of 0.2-6 wt. %. These weight percentages are determined based on the total weight of the film-forming composition.

The two-component acid-curing coating compositions of the present application can be prepared by any suitable mixing method known to those of ordinary skill in the art. For example the film-forming resin composition of coating composition can be made by adding an alkyd resin, a second resin, an amino resin, a solvent, and additional additives, if any, to a container and then mixing the resulting mixture well to form a film-forming composition. An acidic catalyst is then mixed with the film-forming composition described above, thereby forming a two-component acid-curing coating composition in the form of a mixture for use.

In some embodiments according to the present application, when the two-component acid-curing coating composition is applied and cured at room temperature for 7 days or more, the resulting coating has an interlayer adhesion of at least 5 kg, preferably at least 6 kg, more preferably at least 7 kg, even more preferably 8 kg or more, as determined using a BYK-Balanced Beam Scrape Adhesion Tester according to ASTM D2197.

In some embodiments according to the present application, when the two-component acid-curing coating composition is applied and cured at room temperature for 7 days or more, the resulting coating has a surface scratch resistance of at least 150 grams, preferably at least 160 grams, more preferably at least 170 grams, even more preferably at least 180 grams, still more even preferably 200 grams or more, as determined using a BYK-Hoffman scratch hardness tester according to E50TF61-S1.

In some embodiments according to the present application, when the two-component acid-curing coating composition is applied and cured at room temperature for 7 days or more, the resulting coating exhibits a pendulum hardness of 60 or longer, preferably of 70 or longer, more preferably of about 80 or longer, said pendulum hardness being a parameter used to measure flexibility of the resulting coating, as determined according to GB/T-1730.

Therefore, the two-component acid-curing coating composition according to embodiments of the present application is suitable for a wide range of application sites, not only for application sites with low humidity conditions, medium humidity conditions and high humidity conditions, but also for application sites with very high humidity conditions. Thus, it is of great value for promotion in regions and countries with high year-round humidity, such as those in Southeast Asia.

According to a second aspect of the present application, there is provided an article, said article comprising: a substrate having at least one major surface; and a coating at least partially applied directly or indirectly on the at least one major surface of the substrate, wherein the coating is formed by the two-component acid-curing coating composition as described above.

In some embodiments according to the present application, said substrate is selected from wood, wood composite, paper, metal, plastic, fabric, ceramic, cementious material, or any combination thereof.

In some preferred embodiments according to the present application, the above-mentioned two-component acid-curing coating composition is particularly suitable for coating onto a wooden substrate to form a wood product. Any suitable wood substrate known in the art may be used as a wood substrate for the manufacture of the wood product. As used herein, the term “wood substrate” refers to any cellulose/lignin material derived from the hard, fibrous structural tissue of the stems and roots of trees or other woody plants. Wood includes, for example, hardwood and softwood timber cut directly from trees, as well as engineered wood composites made from wood strips, wood scraps, wood fibers, or wood laminates. Examples of wood composites include, but are not limited to, plywood, oriented strand board (OSB), medium density fiberboard (MDF), scrap board, and the like.

As exemplary wood substrates, one or more of Kenwood, Chestnut, Oak, Red Hook Chestnut, Oleander, Presswood, Douglas Fir, Japanese Willow Fir, American Flat Cedar, Japanese Red Pine, Japanese Flat Cypress, Water Walnut, Black Walnut, Maple, Japanese Beech, Japanese Paulownia, Birch, Brach Double, Magnolia, Ash, Teak, Quercus, Liriodendron, Mountain Camphor, Fir, Oak, and Rubberwood may be used.

According to embodiments of the present application, the wood article thus obtained can be used in applications including, but not limited to: household furniture, such as tables, chairs, cabinets, etc.; bedroom and bathroom furniture; office furniture; custom furniture, such as school and children's furniture, hospital furniture, restaurant and hotel furniture, kitchen cabinets and furniture; panels for interior design; interior and exterior windows and doors; interior and exterior window frames and door frames; exterior and interior siding and wood flooring.

### Examples

The following examples describe the present application in more detail, which are for illustrative purposes only. The embodiments of the present application are not limited to these specific examples. Unless otherwise indicated, all parts, percentages, and ratios reported in the following examples are on a weight basis and all reagents used in the examples are commercially available and may be used without further treatment.

### Test Methods

Unless otherwise noted, the following test methods are used in the present application.

### Interlayer Adhesion

This test was used to determine blocking resistance of coatings formed by curing a coating composition. After mixing components of the two-component acid-curing coating composition according to the present application, the resulting mixture was applied to a support test plate at a wet film thickness of 100-150 microns and cured at room temperature for a period of time, and then the interlayer adhesion of the coating was determined using a BYK-Balanced Beam Scratch Adhesion Tester according to ASTM D2197.

### Scratch Resistance

This test was used to determine scratch resistance of coatings formed by curing a coating composition. After mixing components of the two-component acid-curing coating composition according to the present application, the resulting mixture was applied to a support test plate at a wet film thickness of 100-150 microns and cured at room temperature for a period of time, and then the scratch resistance of the coating was determined using a BYK-Hoffman scratch hardness tester according to E50TF61-S1.

### Pendulum Hardness (Coating Flexibility)

The coating composition according to the present application was sprayed evenly on a glass plate with a coating amount of 100 g/square, and dried for 7 days. The resulting coating film was tested for pendulum hardness according to GBT-1730. In the coating flexibility test according to the present invention, the coating with a pendulum hardness over 60 was considered to be qualified, while the coating with a pendulum hardness below 60 was considered to be unqualified.

### Raw Material

Alkyd resin: Allnex Setal 84 saturated fatty acid hydroxy-functional alkyd resin, purchased from Allnex, having a hydroxyl value: 155 mg KOH/g, and a density of approx. 1.085 g/cm³;

Second resin: K-FLEX 188 hydroxy-functional polyester, a linear polyester, purchased from KING, having a hydroxyl value: 318 mg KOH/g, and a density of approx. 0.986 g/cm³;

Amino resins: Cymel 325 amino resin, purchased from Allnex, with a density of approximately 1.08-1.10 g/cm³;

Fluorocarbon resin-modified acrylics polymer: fluorocarbon resin-modified acrylics polymer of BETTERSOL 3987, with a density of about 0.98 g/cm³, purchased from Shanghai Cang Hong Industrial Co;

Epoxy resin: general industrial product;

Castor oil alkyd resin: general industrial product;

Vinyl resins: general industrial product;

Plasticizer: general industrial product;

CAB (cellulose butyl acetate) resin: general industrial product;

Acidic catalyst: general industrial product;

Pigment: general industrial product; and

Solvent: general industrial product.

### Resin Compatibility

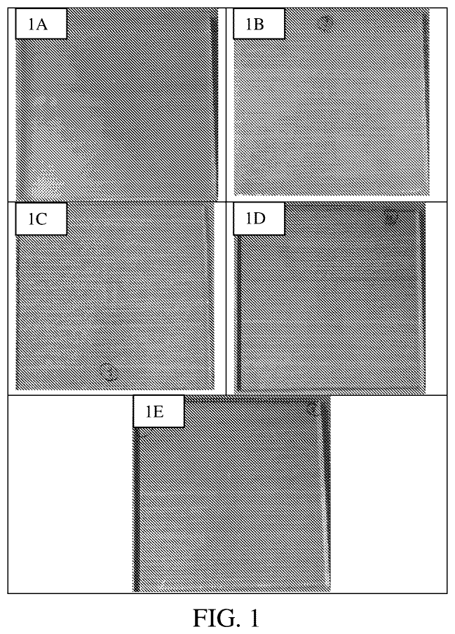

In order to verify compatibility of an amino resin and a second resin, as shown in Table 1, the amino resin, alkyd resin, polyester resin, and butyl acetate in the amounts shown were mixed to form a mixture. Then, the resulting mixture was uniformly sprayed onto a glass plate at a coating amount of 100 g/m² and dried at room temperature for 7 days, and the transparency of each coating was photographed. Photographs of the resulting coatings were shown in FIG. 1.

TABLE 1
Basic composition of film-forming resins

| | Sam- | Sam- | Sam- | Sam- | Sam- |
|---|---|---|---|---|---|
| Composition | ple 1 | ple 2 | ple 3 | ple 4 | ple 5 |
| Amino resin/wt. % | 30 | 30 | 30 | 30 | 25 |
| Alkyd resin/wt. % | — | 10 | 20 | 25 | 28 |
| Polyester resin/wt. % | 30 | 30 | 30 | 25 | 5 |
| Solvent/wt. % | 40 | 30 | 20 | 20 | 40 |
| Total/wt. % | 100 | 100 | 100 | 100 | 100 |

As can be seen from FIG. 1A, when the amino resin and polyester resin at a weight ratio of 1:1 was mixed to form sample 1, the resulting coating was blurred, and thus it could be confirmed that the amino resin and polyester resin were incompatible with each other. It was found by the inventors of the present application that by adding an appropriate amount of alkyd resin to the mixture of amino resin and polyester resin to form samples 2-5, the transparency of the mixture could be continuously increased, as shown in FIGS. 1B-E. When said alkyd resin was present in an amount of 20 wt. % relative to the total weight of said film-forming resin composition (sample 3), the resulting mixture was highly transparent and suitable as a film-forming resin composition for use in formulating coating compositions. Among the above samples, the mixture of sample 5 had the best overall performance and was suitable as a film-forming resin composition for the formulation of coating compositions. Thus, sample 5 was used as Example 1 in the formulation of the following coating compositions.

### Coating Composition

As shown in Table 2, the components in the amounts shown were mixed so as to form a film-forming composition of two-components acid-curing coating composition, and then an acidic catalyst was added to the resulting film-forming composition so as to obtain the two-component acid-curing coating composition ready for use, wherein Example 1 was a two-component acid-curing coating composition in which the resin components comprise an alkyd resin and hydroxyl functional polyester resin; Example 2 was a two-component acid-curing coating composition in which the resin components comprise an alkyd resin and hydroxyl functional polyester resin as well as a fluorocarbon resin modified acrylics polymer; Example 3 was a two-component acid-curing coating composition on the basis of Example 2 in which an epoxy resin was added; Comparative Example 1 was a two-component acid-curing coating composition in which the resin components comprise an alkyd resin and a castor oil alkyd resin; Comparative Example 2 was a two-component acid-curing coating composition in which the resin components comprise an alkyd resin and a vinyl resin; Comparative Example 3 was a two-component acid-curing coating composition in which the resin components comprise an alkyd resin and a CAB resin; Comparative Example 4 was a two-component acid-curing coating composition in which the resin components comprise an alkyd resin and in which a plasticizer is included; and Control I was a two-component acid-curing coating composition in which the resin components comprise an alkyd resin.

The above coating compositions of Examples 1-3, Example 2, Comparative Examples 1-4, and Control I were sprayed onto the surface of a support substrate at a wet coating thickness of 150 microns. The resulting coatings were dried at room temperature for a period of time. The flexibility, interlayer adhesion and scratch resistance were then determined according to the method described in the previous test section, and the results were summarized in Table 3 below.

TABLE 2
Components of two-component acid-curing coating compositions and their amount

| | Example | Example | Example | Comparative | Comparative | Comparative | Comparative | Control |
|---|---|---|---|---|---|---|---|---|
| Raw material/g | 1 | 2 | 3 | Example 1 | Example 2 | Example 3 | Example 4 | 1 |
| Component A | | | | | | | | |
| Alkyd Resin | 28 | 28 | 28 | 28 | 28 | 28 | 28 | 33 |
| Second resin | 5 | 5 | 4 | — | — | — | — | — |
| Fluorocarbon | — | 0.5 | 0.5 | — | — | — | — | — |
| resin-modified | | | | | | | | |
| acrylics polymer | | | | | | | | |
| Epoxy resin | — | — | 1 | — | — | — | — | — |
| Castor oil alkyd | — | — | — | 5 | — | — | — | — |
| resin | | | | | | | | |
| Vinyl resins | — | — | — | — | 5 | — | — | — |
| CAB resin | — | — | — | — | — | 5 | — | — |
| Plasticizer | — | — | — | — | — | — | 3 | — |
| Amino Resin | 25 | 25 | 25 | 25 | 25 | 25 | 25 | 25 |
| Pigments | 2 | 2 | 2 | 2 | 2 | 2 | 2 | 2 |
| Solvent | 36.5 | 36 | 36 | 36.5 | 36.5 | 36.5 | 39.5 | 36.5 |
| Other additional | 3.5 | 3.5 | 3.5 | 3.5 | 3.5 | 3.5 | 3.5 | 3.5 |
| additives | | | | | | | | |
| Total | 100 | 100 | 100 | 100 | 100 | 100 | 100 | 100 |
| Component B | | | | | | | | |
| Acidic catalyst | 2 | 2 | 2 | 2 | 2 | 2 | 2 | 2 |

TABLE 3
Paint film properties of two-component acid-curing coating compositions

| | | Scratch resistance (grams), | | | Interlayer Adhesion (kg), | | |
|---|---|---|---|---|---|---|---|
| | | requirement >150 grams | | | requirement >5 kg | | |
| | | After 7 | After 15 | After 30 | After 7 | After 15 | After 30 |
| Examples | Flexibility | days | days | days | days | days | days |
| Control 1 | unqualified | 120 | 120 | 130 | 5 | 4 | 3 |
| Example 1 | qualified | 130 | 130 | 150 | 8 | 7 | 7 |
| Example 2 | qualified | 150 | 170 | 200 | 7 | 6 | 6 |
| Example 3 | qualified | 160 | 160 | 200 | 8 | 7 | 7 |
| Comparative Example 1 | qualified | 100 | 100 | 110 | 5 | 4 | 4 |
| Comparative Example 2 | qualified | 100 | 110 | 120 | 5 | 5 | 4 |
| Comparative Example 3 | qualified | 110 | 110 | 120 | 5 | 4 | 4 |
| Comparative Example 4 | qualified | 90 | 100 | 110 | 5 | 5 | 4 |

As can be seen from the results of Example 1 and Control 1, in the formulation of the two-component acid-curing coating composition, by adding a second resin that has a greater density difference with the amino resin and is therefore incompatible with each there, the resulting paint film formed from the acid-curing coating composition not only has significantly improved surface performances, but also has improved flexibility. The resulting paint film formed from the coating composition has significantly better interlayer adhesion and surface scratch resistance both while keeping good flexibility. Furthermore, by further adding a fluorocarbon resin modified acrylic polymer, which is less dense than the alkyd resin and the second resin, on the basis of the above Example 1, the surface performances of the resulting paint film formed from the acid-cured paint composition can be further improved so that the paint film can pass the 200 g Hoffman test. In addition, by further adding an epoxy resin, on the basis of the above Example 2, the overall surface performances of the resulting paint film formed from the acid-cured coating composition can be further improved, wherein the paint film formed therefrom has not only optimal scratch resistance but also optimal interlayer adhesion, which was unexpected prior to the present application.

In contrast, in the formulation of the two-component acid-curing coating composition comprising an alkyd resin and an amino resin, the flexibility of the resulting paint film may be improved by adding a plasticizer or a soft resin, such as a castor oil alkyd resin, a vinyl resin, or a cellulose acetate resin, the surface performances of the resulting paint film, especially interlayer adhesion and surface hardness, are significantly reduced, as shown in Comparative Examples 1-4.

Although the present invention is described with reference to a large number of embodiments and examples, it is readily apparent to those skilled in the art that variations can be made to the present invention without departing from the principles disclosed in the foregoing specification. For example, without departing from the principles disclosed in the preceding specification, a number of features or preferred embodiments described herein may be combined to obtain a technical solution that should be understood as belonging to what is documented herein. Such variations are considered to be included in the following claims, unless the claims are expressly specified otherwise. Accordingly, the embodiments detailed herein are exemplary only and are not intended to limit the scope of the invention, which is the complete scope of the appended claims and any and all equivalents thereof.

What is claimed is:

1. A two-component acid-curing coating composition comprising:
a) a film-forming resin composition comprising at least one alkyd resin, at least one second resin, and at least one amino resin; and
b) at least one acidic catalyst,
wherein at least one second resin is incompatible with at least one amino resin; and
wherein the at least one alkyd resin is present in an amount of at least 20 wt. % relative to the total weight of the film-forming resin composition.

2. The two-component acid-curing coating composition according to claim 1, wherein at least one second resin differs from at least one amino resin in density by at least 8%, preferably at least one second resin differs from at least one amino resin in density by at least 10%, more preferably at least one second resin differs from at least one amino resin in density by at least 12% and no greater than 20%.

3. The two-component acid-curing coating composition according to claim 2, wherein at least one second resin has a density lower than at least one amino resin by at least 8%, preferably by at least 10%, more preferably by at least 12% and no greater than 20%.

4. The two-component acid-curing coating composition according to claim 1, wherein at least one second resin differs from at least one amino resin in solubility parameter by at least 20%, preferably at least one second resin differs from at least one amino resin in solubility parameter by at least 25%, more preferably at least one second resin differs from at least one amino resin in solubility parameter by at least 30% and no greater than 60%.

5. The two-component acid-curing coating composition according to claim 1, wherein a mixture of at least one second resin and at least one amino resin at a weight ratio of 1:1 has a transparency of not more than 70%.

6. The two-component acid-curing coating composition according to claim 1, wherein the at least one alkyd resin comprises at least one saturated fatty acid-based alkyd resin with low oil content, at least one saturated fatty acid-based alkyd resin with medium oil content, at least one saturated fatty acid-based alkyd resin with high oil content, at least one saturated fatty acid-based alkyd resin with extreme high oil content, or combinations thereof, preferably comprising at least one saturated fatty acid-based alkyd resin with low oil content.

7. The two-component acid-curing coating composition according to claim 1, wherein the at least one alkyd resin has a hydroxyl value in the range of 140 to 240 mg KOH/g resin, preferably in the range of 140-200 mg KOH/g resin, more preferably in the range of 140-180 mg KOH/g resin, and still more preferably in the range of 145-170 mg KOH/g resin, as determined according to DIN EN ISO 4629-2:2016.

8. The two-component acid-curing coating composition according to claim 1, wherein the at least one alkyd resin has a density in the range of 1.09 to 1.10 g/cm³.

9. The two-component acid-curing coating composition according to claim 1, wherein the at least one second resin comprises a hydroxyl-functional polyester, preferably linear.

10. The two-component acid-curing coating composition according to claim 1, wherein the at least one second resin has a hydroxyl value in the range of 260 to 400 mg KOH/g resin,
preferably in the range of 290 to 380 mg KOH/g resin, more preferably in the range of 300 to 350 mg KOH/g resin, still more preferably in the range of 315 to 330 mg KOH/g resin;
alternatively, preferably in the range of 140-240 mg KOH/g resin, more preferably 140-200 mg KOH/g resin, even more preferably 140-180 mg KOH/g resin;
alternatively, preferably in the range of 260-400 mg KOH/g resin, preferably 290-380 mg KOH/g resin, and more preferably 300-350 mg KOH/g resin, as determined according to DIN EN ISO 4629-2:2016.

11. The two-component acid-curing coating composition according to claim 1, wherein the at least one second resin has a density in the range of 0.97 to 0.99 g/cm³.

12. The two-component acid-curing coating composition according to claim 1,
wherein the at least one amino resin is a reaction product of at least one aldehyde with at least one amino compound; and
wherein the at least one amino compound comprises melamine, urea, phenyl-substituted melamine, methyl-substituted melamine, or combinations thereof.

13. The two-component acid-curing coating composition according to claim 1, wherein the at least one amino resin is etherified, preferably with n-butanol, isobutanol, methanol, or combinations thereof.

14. The two-component acid-curing coating composition according to claim 1, wherein the at least one amino resin has a density in the range of 1.09 to 1.10 g/cm³.

15. The two-component acid-curing coating composition according to claim 1, wherein the film-forming resin composition further comprises at least one fluorocarbon resin-modified acrylics polymer.

16. The two-component acid-curing coating composition according to claim 15, wherein the at least one fluorocarbon resin-modified acrylics polymer has a density less than three of the at least one alkyd resin, the at least one amino resin and the at least one second resin.

17. The two-component acid-curing coating composition according to claim 1, wherein the film-forming resin composition comprises, relative to the total weight of the film-forming resin composition
20-35 wt. % of the at least one alkyd resin
1-30 wt. %, preferably 1-20 wt. % of the at least one second resin
20-30 wt. % of the at least one amino resin,
0-2 wt. % of the at least one fluorocarbon resin-modified acrylics polymer
2-40 wt. % of at least one solvent; and
0-5 wt. % of the at least one additional additive, wherein the at least one additional additive comprises: at least one pigment, at least one filler, at least one anti-settling agent, at least one thickener, at least one dispersant, at least one wetting agent, at least one film forming aid, at least one coupling agent, at least one fungicide, at least one anti-mold agent, or combinations thereof.

18. The two-component acid-curing coating composition according to claim 1, wherein the at least one acidic catalyst is selected from the group comprising p-toluenesulfonic acid, benzenesulfonic acid, methanesulfonic acid, dinonylnaphthalenesulfonic acid, dinonylnaphthalenedisulfonic acid, dodecylbenzenesulfonic acid, oxalic acid, maleic acid, phthalic acid, acrylic acid, mono(di)alkyl phosphate, phosphoric acid, mono(di)alkyl pyrophosphate, or combinations thereof.

19. The two-component acid-curing coating composition according to claim 1, wherein when the two-component acid-curing coating composition is applied and cured at room temperature for 7 days or more, the resulting coating has an interlayer adhesion of at least 5 kg, as determined using a BYK-Balanced Beam Scrape Adhesion Tester according to ASTM D2197.

20. The two-component acid-curing coating composition according to claim 1, wherein when the two-component acid-curing coating composition is applied and cured at room temperature for 7 days or more, the resulting coating has a surface scratch resistance of at least 150 grams, as determined using a BYK-Hoffman scratch hardness tester according to E50TF61-S1.

21. An article comprising
a substrate having at least one major surface; and
a coating at least partially applied directly or indirectly on the at least one major surface of the substrate,
wherein the coating is formed by the two-component acid-curing coating composition according to claim 1.

22. The article of claim 21, wherein the substrate is selected from wood, wood composite, paper, metal, plastic, fabric, ceramic, cementious material, or combinations thereof.
